(19) United States
(12) Patent Application Publication
(10) Pub. No.: US 2025/0200417 A1
(43) Pub. Date: Jun. 19, 2025

(54) ENABLING QUANTUM MACHINE LEARNING TO BE USED EFFECTIVELY WITH CLASSICAL DATA BY MAPPING CLASSICAL DATA INTO A QUANTUM STATE SPACE

(71) Applicant: International Business Machines Corporation, Armonk, NY (US)

(72) Inventors: Brian Leo Quanz, Yorktown Heights, NY (US); Jae-Eun Park, Wappingers Falls, NY (US); Chee-Kong Lee, Tacoma, WA (US); Vaibhaw Kumar, Frederick, MD (US)

(21) Appl. No.: 18/539,540

(22) Filed: Dec. 14, 2023

(51) Int. Cl. G06N 10/60

(52) U.S. Cl. CPC G06N 10/60

(57) ABSTRACT

A method, system, and computer program product for enabling quantum machine learning to be used effectively with classical data. Classical data, which may consist of a large sample size and a large number of features, is mapped into quantum state space forming quantum data using a classical machine learning model. Classical data refers to data subject to the laws of classical physics. Quantum state space refers to an abstract space in which different “positions” represent, not literal locations, but rather quantum states of a physical system. The dimensionality of the quantum state space corresponds to 2 raised to the power of the number of qubits. Quantum machine learning may then be performed on a quantum computer using the formed quantum data. As a result, quantum machine learning is enabled to be used effectively with classical data while utilizing a small number of qubits.

### TECHNICAL FIELD

The present disclosure relates generally to quantum machine learning, and more particularly to enabling quantum machine learning to be used effectively with classical data by mapping classical data into a quantum state space.

### BACKGROUND

Quantum machine learning refers to machine learning algorithms for the analysis of classical data (data represented and stored on classical computers subject to the laws of classical physics, such as numbers, vectors, matrices, etc., as opposed to quantum data, which is data represented by the state of a quantum computer) with at least some parts of the algorithms executed on a quantum computer. While machine learning algorithms are used to compute immense quantities of data, quantum machine learning utilizes qubits and quantum operations or specialized quantum systems to improve computational speed and data storage performed by algorithms in a program. This includes hybrid methods that involve both classical and quantum processing, where computationally difficult subroutines are outsourced to a quantum device. These routines can be more complex in nature and executed faster on a quantum computer.

Quantum-enhanced machine learning refers to quantum or hybrid quantum-classical algorithms that solve tasks in machine learning, thereby improving and often expediting classical machine learning techniques. Such algorithms typically require one to encode the given classical data set into a quantum computer to make it accessible for quantum information processing, which is the process of converting the numeric representation on a classical computer, such as a vector of real numbers, into a quantum state of a quantum computer. Subsequently, quantum information processing routines are applied and the result of the quantum computation is read out by measuring characteristics of the quantum system. For example, the outcome of the measurement of a qubit (quantum mechanical analogue of a classical bit) can reveal the result of a binary classification task.

Such classical data to be encoded by the quantum or hybrid quantum-classical algorithm may include a large sample size with a large number of features, which represent a measurable piece of data (e.g., name, sales) that can be used for analysis. Unfortunately, quantum machine learning can only be broadly applied to a small number of qubits and samples given current and near-term quantum computing technology. The current main approach to quantum machine learning on a quantum computer involves using on the order of 1 qubit per feature. However, since there are typically a large number of features in the classical data set, such an approach utilizes a sizeable number of qubits, often even more than the effective number of qubits of current and near-term quantum computers. Even when a quantum computer with a sufficient number of qubits exits, when such a large number of qubits are used, issues can arise, such as issues with shot requirements (a shot is an execution of the quantum circuit), curse of dimensionality (various phenomena that arise when analyzing and organizing data in high-dimensional spaces that do not occur in low-dimensional settings), measurement issues, such as a vanishingly small probability of measuring state overlaps even for similar states, noise, exponential concentration, etc.

As a result, because there are such a large number of features in the classical data set, lossy compression (e.g., principal component analysis) is typically used to reduce the number of features in order to reduce the number of qubits, which typically results in poorer performance in comparison to classical machine learning using all of the features.

Consequently, an approach has been developed that encodes multiple features per qubit as a sequence of rotations. Unfortunately, such an approach can lead to the loss of key information.

Hence, there is not currently a means for broadly enabling quantum machine learning to be used effectively with classical data with a large sample size and a large number of features.

### SUMMARY

In one embodiment of the present disclosure, a method for enabling quantum machine learning to be used effectively with classical data comprises receiving the classical data. The method further comprises mapping the classical data into a quantum state space forming quantum data using a classical machine learning model. The method additionally comprises performing the quantum machine learning on a quantum computer using the formed quantum data.

Furthermore, in one embodiment of the present disclosure, the method additionally comprises receiving data points of the classical data. The method further comprises generating different views of the data points of the classical data. The method additionally comprises encoding the different views of the data points of the classical data by an encoder to representations. Furthermore, the method comprises comparing a similarity of the representations among the different views of the data points of the classical data to form a similarity measure. Additionally, the method comprises optimizing parameters of the encoder using the similarity measure.

Additionally, in one embodiment of the present disclosure, the representations correspond to quantum state representations derived from quantum circuit operations.

Furthermore, in one embodiment of the present disclosure, the different views of the data points of the classical data are generated via corruption of the classical data or corruption of an initial encoded quantum state representation by quantum hardware noise.

Additionally, in one embodiment of the present disclosure, the parameters of the encoder are optimized using the similarity measure such that a final quantum state representation of the different views of the data points of the classical data has a property that a representation of a first data point of the classical data is more similar to a representation of a corrupted view of the first data point of the classical data on average than a similarity between the representation of the first data point of the classical data and a representation of a corrupted view of other data points of the classical data.

Furthermore, in one embodiment of the present disclosure, the data points of the classical data correspond to a first type of data, where the encoder is trained to encode different views of other data points of the first type of data of the classical data across different data sets.

Additionally, in one embodiment of the present disclosure, the representations correspond to quantum state representations or new classical representations.

Other forms of the embodiments of the method described above are in a system and in a computer program product.

Accordingly, embodiments of the present disclosure enable quantum machine learning to be used effectively with classical data with a large sample size and a large number of features while utilizing a small number of qubits.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a communication system for practicing the principles of the present disclosure in accordance with an embodiment of the present disclosure;

FIG. 2 is a diagram of the software components of the classical computer for enabling quantum machine learning to be used effectively with classical data in accordance with an embodiment of the present disclosure.

FIG. 3 illustrates the contrastive learning approach in accordance with an embodiment of the present disclosure;

FIG. 4 illustrates a feature map in accordance with an embodiment of the present disclosure;

FIG. 5 illustrates embedding the quantum state features into two-dimensional space in accordance with an embodiment of the present disclosure;

FIG. 6 illustrates an embodiment of the present disclosure of the hardware configuration of the classical computer which is representative of a hardware environment for practicing the present disclosure; and

FIG. 7 is a flowchart of a method for enabling quantum machine learning to be used effectively with classical data in accordance with an embodiment of the present disclosure.

### DETAILED DESCRIPTION

In one embodiment of the present disclosure, a method for enabling quantum machine learning to be used effectively with classical data comprises receiving the classical data. The method further comprises mapping the classical data into a quantum state space forming quantum data using a classical machine learning model. The method additionally comprises performing the quantum machine learning on a quantum computer using the formed quantum data.

In this manner, quantum machine learning is enabled to be used effectively with classical data with a large sample size and a large number of features while utilizing a small number of qubits.

Furthermore, in one embodiment of the present disclosure, the method additionally comprises receiving data points of the classical data. The method further comprises generating different views of the data points of the classical data. The method additionally comprises encoding the different views of the data points of the classical data by an encoder to representations. Furthermore, the method comprises comparing a similarity of the representations among the different views of the data points of the classical data to form a similarity measure. Additionally, the method comprises optimizing parameters of the encoder using the similarity measure.

In this manner, quantum machine learning is enabled to be used effectively with classical data with a large sample size and a large number of features while utilizing a small number of qubits.

Additionally, in one embodiment of the present disclosure, the representations correspond to quantum state representations derived from quantum circuit operations.

In this manner, classical data, including the features of the classical data, are encoded to representations, such as quantum state representations, which correspond to quantum circuit operations, such as a series of rotation operations and entanglement or 2-qubit operations.

Furthermore, in one embodiment of the present disclosure, the different views of the data points of the classical data are generated via corruption of the classical data or corruption of an initial encoded quantum state representation by quantum hardware noise.

In this manner, the final representations for the different views of the data points of the classical data have the property that a data point's representation and the representation of the corrupted view of that data point will be more similar on average than the similarity between that data point's representation and the representations of the corrupted views of the other data points.

Additionally, in one embodiment of the present disclosure, the parameters of the encoder are optimized using the similarity measure such that a final quantum state representation of the different views of the data points of the classical data has a property that a representation of a first data point of the classical data is more similar to a representation of a corrupted view of the first data point of the classical data on average than a similarity between the representation of the first data point of the classical data and a representation of a corrupted view of other data points of the classical data.

In this manner, the final representations for the different views of the data points of the classical data have the property that a data point's representation and the representation of the corrupted view of that data point will be more similar on average than the similarity between that data point's representation and the representations of the corrupted views of the other data points.

Furthermore, in one embodiment of the present disclosure, the data points of the classical data correspond to a first type of data, where the encoder is trained to encode different views of other data points of the first type of data of the classical data across different data sets.

In this manner, once the encoder is trained, the encoder may be utilized to encode future data of the same type, potentially from other datasets.

Additionally, in one embodiment of the present disclosure, the representations correspond to quantum state representations or new classical representations.

In this manner, classical data, including the features of the classical data, are encoded to representations, such as quantum state representations or new classical representations, such as based on measurements of the quantum state and possible further classical transformations.

Other forms of the embodiments of the method described above are in a system and in a computer program product.

As stated above, quantum-enhanced machine learning refers to quantum or hybrid quantum-classical algorithms that solve tasks in machine learning, thereby improving and often expediting classical machine learning techniques. Such algorithms typically require one to encode the given classical data set into a quantum computer to make it accessible for quantum information processing, which is the process of converting the numeric representation on a classical computer, such as a vector of real numbers, into a quantum state of a quantum computer. Subsequently, quantum information processing routines are applied and the result of the quantum computation is read out by measuring characteristics of the quantum system. For example, the outcome of the measurement of a qubit (quantum mechanical analogue of a classical bit) can reveal the result of a binary classification task.

Such classical data to be encoded by the quantum or hybrid quantum-classical algorithm may include a large sample size with a large number of features, which represent a measurable piece of data (e.g., name, sales) that can be used for analysis. Unfortunately, quantum machine learning can only be broadly applied to a small number of qubits and samples given current and near-term quantum computing technology. The current main approach to quantum machine learning on a quantum computer involves using on the order of 1 qubit per feature. However, since there are typically a large number of features in the classical data set, such an approach utilizes a sizeable number of qubits, often even more than the effective number of qubits of current and near-term quantum computers. Even when a quantum computer with a sufficient number of qubits exits, when such a large number of qubits are used, issues can arise, such as issues with shot requirements (a shot is an execution of the quantum circuit), curse of dimensionality (various phenomena that arise when analyzing and organizing data in high-dimensional spaces that do not occur in low-dimensional settings), measurement issues, such as a vanishingly small probability of measuring state overlaps even for similar states, noise, exponential concentration, etc.

As a result, because there are such a large number of features in the classical data set, lossy compression (e.g., principal component analysis) is typically used to reduce the number of features in order to reduce the number of qubits, which typically results in poorer performance in comparison to classical machine learning using all of the features.

Consequently, an approach has been developed that encodes multiple features per qubit as a sequence of rotations. Unfortunately, such an approach can lead to the loss of key information.

Hence, there is not currently a means for broadly enabling quantum machine learning to be used effectively with classical data with a large sample size and a large number of features.

The embodiments of the present disclosure provide the means for enabling quantum machine learning to be used effectively with classical data with a large sample size and a large number of features while utilizing a small number of qubits by encoding data points with fewer qubits or with a part of a quantum state of the quantum state space so that the quantum state can be more fully utilized. A quantum state space, as used herein, is an abstract space in which different “positions” represent, not literal locations, but rather quantum states of a physical system. It is the quantum analog of the phase space of classical mechanics. The dimensionality of the quantum state space corresponds to 2 raised to the power of the number of qubits. As a result, a significant number of features may now be represented in a meaningful way using a small number of qubits. For example, over 100 features may be represented by 8 qubits, which form a quantum state space of 2\hat{ }8, representing a 256 dimension feature space. By encoding data points with fewer qubits or a part of a quantum state, the total quantum state may be more fully utilized thereby enabling the encoding of more data points or to perform other computations. These and other features will be discussed in further detail below.

In some embodiments of the present disclosure, the present disclosure comprises a method, system, and computer program product for enabling quantum machine learning to be used effectively with classical data. In one embodiment of the present disclosure, different views of the data points of the classical data, which may consist of a large sample size and a large number of features, are generated. Such different views of the data points may be generated via corruption of the classical data or corruption of an initial encoded quantum state representation by quantum hardware noise. Such different views of the data points of the classical data may then be encoded to representations (e.g., quantum state representations) by an encoder. A similarity of the representations among the different views of the data points of the classical data may then be compared to form a similarity measure, which is used to optimize the parameters of the encoder. By optimizing the parameters of the encoder in such a manner, the final representations for the different views of the data points of the classical data have the property that a representation of a first data point of the classical data is more similar to a representation of a corrupted view of the first data point of the classical data on average than a similarity between the representation of the first data point of the classical data and a representation of a corrupted view of other data points of the classical data. As a result of optimizing the parameters of the encoder, such as over training data (classical data corresponding to training data), the encoder is effectively trained to encode the classical data to a representation (e.g., quantum state representation) for a given dataset or type of data. In this manner, once the encoder is trained, the encoder may be utilized to encode future data of the same type. Furthermore, the encoder may be trained utilizing a small number of features of the classical data and then be applied to encode classical data with a greater number of features using more qubits. As a result, quantum machine learning is enabled to be used effectively with classical data with a large sample size and a large number of features.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

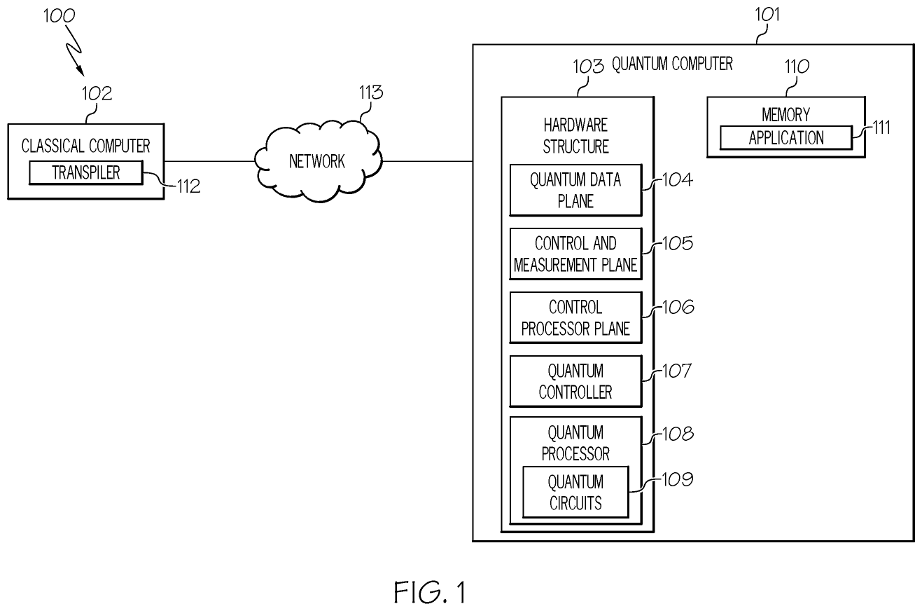

Referring now to the Figures in detail, FIG. 1 illustrates an embodiment of the present disclosure of a communication system 100 for practicing the principles of the present disclosure. Communication system 100 includes a quantum computer 101 configured to perform quantum computations, such as the types of computations that harness the collective properties of quantum states, such as superposition, interference, and entanglement, as well as a classical computer 102 in which information is stored in bits that are represented logically by either a 0 (off) or a 1 (on). Examples of classical computer 102 include, but are not limited to, a portable computing unit, a Personal Digital Assistant (PDA), a laptop computer, a mobile device, a tablet personal computer, a smartphone, a mobile phone, a navigation device, a gaming unit, a desktop computer system, a workstation, and the like configured with the capability of connecting to network 113 (discussed below).

In one embodiment, classical computer 102 is used to set up the state of quantum bits in quantum computer 101 and then quantum computer 101 starts the quantum process. Furthermore, in one embodiment, classical computer 102 is configured to enable quantum machine learning to be used effectively with classical data as discussed further below.

In one embodiment, a hardware structure 103 of quantum computer 101 includes a quantum data plane 104, a control and measurement plane 105, a control processor plane 106, a quantum controller 107, and a quantum processor 108. While depicted as being located on a single machine, quantum data plane 104, control and measurement plane 105, and control processor plane 106 may be distributed across multiple computing machines, such as in a cloud computing architecture, and communicate with quantum controller 107, which may be located in close proximity to quantum processor 108.

Quantum data plane 104 includes the physical qubits or quantum bits (basic unit of quantum information in which a qubit is a two-state (or two-level) quantum-mechanical system) and the structures needed to hold them in place. In one embodiment, quantum data plane 104 contains any support circuitry needed to measure the qubits' state and perform gate operations on the physical qubits for a gate-based system or control the Hamiltonian for an analog computer. In one embodiment, control signals routed to the selected qubit(s) set a state of the Hamiltonian. For gate-based systems, since some qubit operations require two qubits, quantum data plane 104 provides a programmable “wiring” network that enables two or more qubits to interact.

Control and measurement plane 105 converts the digital signals of quantum controller 107, which indicates what quantum operations are to be performed, to the analog control signals needed to perform the operations on the qubits in quantum data plane 104. In one embodiment, control and measurement plane 105 converts the analog output of the measurements of qubits in quantum data plane 104 to classical binary data that quantum controller 107 can handle.

Control processor plane 106 identifies and triggers the sequence of quantum gate operations and measurements (which are subsequently carried out by control and measurement plane 105 on quantum data plane 104). These sequences execute the program, provided by quantum processor 108, for implementing a quantum algorithm.

In one embodiment, control processor plane 106 runs the quantum error correction algorithm (if quantum computer 101 is error corrected).

In one embodiment, quantum processor 108 uses qubits to perform computational tasks. In the particular realms where quantum mechanics operate, particles of matter can exist in multiple states, such as an “on” state, an “off” state, and both “on” and “off” states simultaneously. Quantum processor 108 harnesses these quantum states of matter to output signals that are usable in data computing.

In one embodiment, quantum processor 108 performs algorithms which conventional processors are incapable of performing efficiently.

In one embodiment, quantum processor 108 includes one or more quantum circuits 109. Quantum circuits 109 may collectively or individually be referred to as quantum circuits 109 or quantum circuit 109, respectively. A “quantum circuit 109,” as used herein, refers to a model for quantum computation in which a computation is a sequence of quantum logic gates, measurements, initializations of qubits to known values and possibly other actions. A “quantum logic gate,” as used herein, is a reversible unitary transformation on at least one qubit. Quantum logic gates, in contrast to classical logic gates, are all reversible. Examples of quantum logic gates include RX (performs e^{iθX/2}, which corresponds to a rotation of the qubit state around the X-axis by the given angle theta θ on the Bloch sphere), RY (performs e^{iθY/2}, which corresponds to a rotation of the qubit state around the Y-axis by the given angle theta θ on the Bloch sphere), RXX (performs the operation e^{(-iθX⊗X/2)} on the input qubit), RZZ (takes in one input, an angle theta θ expressed in radians, and it acts on two qubits), etc. In one embodiment, quantum circuits 109 are written such that the horizontal axis is time, starting at the left-hand side and ending at the right-hand side.

Furthermore, in one embodiment, quantum circuit 109 corresponds to a command structure provided to control processor plane 106 on how to operate control and measurement plane 105 to run the algorithm on quantum data plane 104/quantum processor 108.

Furthermore, quantum computer 101 includes memory 110, which may correspond to quantum memory. In one embodiment, memory 110 is a set of quantum bits that store quantum states for later retrieval. The state stored in quantum memory 110 can retain quantum superposition.

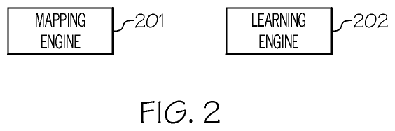

In one embodiment, memory 110 stores an application 111 that may be configured to implement one or more of the methods described herein in accordance with one or more embodiments. For example, application 111 may implement a program for enabling quantum machine learning to be used effectively with classical data as discussed further below in connection with FIGS. 2-5 and 7. Examples of memory 110 include light quantum memory, solid quantum memory, gradient echo memory, electromagnetically induced transparency, etc.

Furthermore, in one embodiment, classical computer 102 includes a “transpiler 112,” which as used herein, is configured to rewrite an abstract quantum circuit 109 into a functionally equivalent one that matches the constraints and characteristics of a specific target quantum device. In one embodiment, transpiler 112 (e.g., qiskit.transpiler, where Qiskit® is an open-source software development kit for working with quantum computers at the level of circuits, pulses, and algorithms) rewrites a given input circuit to match the topology of a specific quantum device and/or to optimize the quantum circuit for execution. In one embodiment, transpiler 112 converts a trained machine learning model upon execution on quantum hardware 103 to its elementary instructions and maps it to physical qubits.

In one embodiment, quantum machine learning models are based on variational quantum circuits 109. Such models consist of data encoding, processing parameterized with trainable parameters, and measurement/post-processing.

In one embodiment, the number of qubits (basic unit of quantum information in which a qubit is a two-state (or two-level) quantum-mechanical system) is determined by the number of features in the data. This processing stage may include multiple layers of parameterized gates. As a result, in one embodiment, the number of trainable parameters is (number of features)*(number of layers).

Furthermore, as shown in FIG. 1, classical computer 102, which is used to set up the state of quantum bits in quantum computer 101, may be connected to quantum computer 101 via network 113.

Network 113 may be, for example, a quantum network, a local area network, a wide area network, a wireless wide area network, a circuit-switched telephone network, a Global System for Mobile Communications (GSM) network, a Wireless Application Protocol (WAP) network, a WiFi network, an IEEE 802.11 standards network, a cellular network and various combinations thereof, etc. Other networks, whose descriptions are omitted here for brevity, may also be used in conjunction with system 100 of FIG. 1 without departing from the scope of the present disclosure.

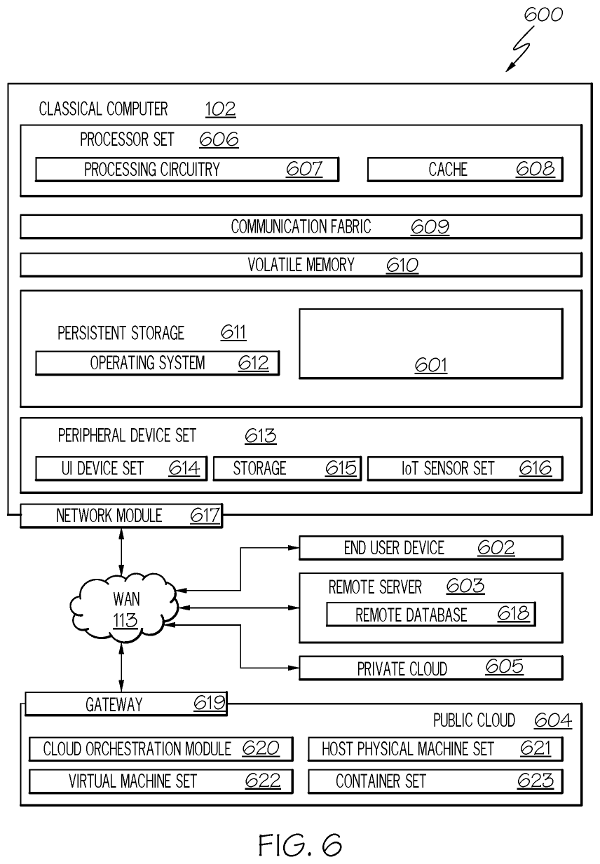

Furthermore, classical computer 102 is configured to enable quantum machine learning to be used effectively with classical data as discussed further below in connection with FIGS. 2-5 and 7. A description of the software components of classical computer 102 is provided below in connection with FIG. 2 and a description of the hardware configuration of classical computer 102 is provided further below in connection with FIG. 6.

System 100 is not to be limited in scope to any one particular network architecture. System 100 may include any number of quantum computers 101, classical computers 102, and networks 113.

A discussion regarding the software components used by classical computer 102 for enabling quantum machine learning to be used effectively with classical data is provided below in connection with FIG. 2.

FIG. 2 is a diagram of the software components of classical computer 102 (FIG. 1) for enabling quantum machine learning to be used effectively with classical data in accordance with an embodiment of the present disclosure.

Referring to FIG. 2, in conjunction with FIG. 1, classical computer 102 includes a mapping engine 201 configured to map classical data into quantum state space forming quantum data.

Classical data, as used herein, refers to data subject to the laws of classical physics, such as numbers, vectors, matrices, etc. Quantum state space, as used herein, refers to an abstract space in which different “positions” represent, not literal locations, but rather quantum states of a physical system. It is the quantum analog of the phase space of classical mechanics. The dimensionality of the quantum state space corresponds to 2 raised to the power of the number of qubits. As a result, a significant number of features may now be represented in a meaningful way using a small number of qubits. For example, over 100 features may be represented by 8 qubits, which form a quantum state space of 2\hat{ }8, representing a 256 dimension feature space.

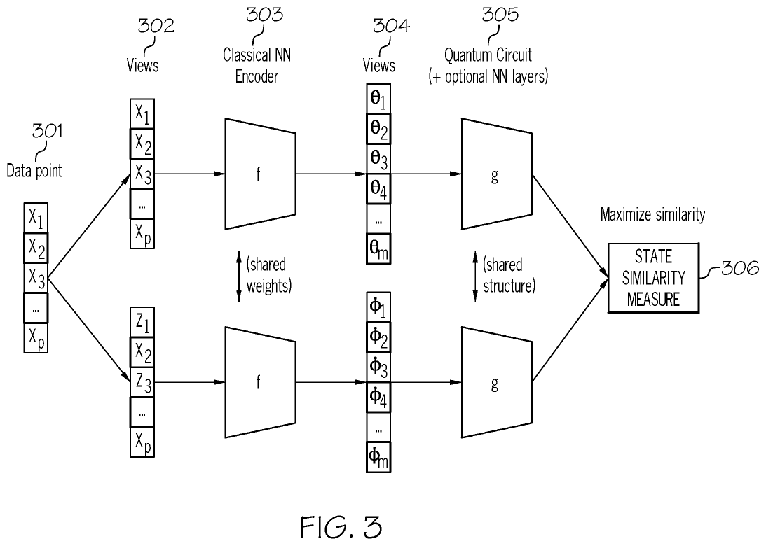

In one embodiment, mapping engine 201 maps the classical data into quantum state space using a contrastive learning approach as illustrated in FIG. 3. In such an approach, the approach learns how to best encode the classical data for subsequent quantum machine learning.

FIG. 3 illustrates the contrastive learning approach in accordance with an embodiment of the present disclosure.

Referring to FIG. 3, mapping engine 201 generates different views 302 of the data points 301 of the classical data. “Views” 302, as used herein, refer to the different transformations being performed on the same data points 301.

In one embodiment, mapping engine 201 generates different views 302 of data points 301 by corrupting data points 301 via different corruption mechanisms. “Corruption,” as used herein, refers to altering the data points, such as changing the values of the data points. In one embodiment, the different views 302 of data points 301 are generated via corruption of the classical data. In one embodiment, such corruption is performed by mapping engine 201 by purposely writing zeroes in the middle of the values of data points 301 at randomly chosen positions for each optimization iteration. In another embodiment, such corruption is performed by replacing randomly selected values with other values randomly sampled from the set of all values for the same feature.

Alternatively, in one embodiment, the different views 302 of data points 301 are generated via corruption of an initial encoded quantum state representation, such as by quantum hardware noise. In one embodiment, such corruption may occur at a latter stage in the process, such as when the data is encoded to the quantum state and as this quantum state is manipulated with quantum circuit operations. In one embodiment, the different views 302 of data points 301 are generated by applying quantum operations with different noise profiles, such as quantum operations with reduced or no noise and quantum operations exhibiting quantum hardware noise. For example, quantum operations with no noise may be applied, for example, via simulation, or with reduced noise via error-mitigation and suppression. In another example, noisy quantum hardware operations from quantum hardware noise are utilized for the alternative corrupted representation, such as in the case with no error mitigation or suppression. Examples of quantum hardware noise include, but are not limited to, local radiation, cosmic rays, influence neighboring qubits exert on each other, etc. In this manner, the learned encoding (discussed below) can adapt to the quantum hardware noise present in the system (i.e., the final encoding learns to be robust to this noise).

Furthermore, as illustrated in FIG. 3, mapping engine 201 encodes such different views 302 of data points 301 to representations, such as quantum state representations or new classical representations based on measurements of the quantum state and possible further classical transformations, using an encoder(s) 303. Such a process is referred to as “quantum data encoding” or “embedding.” An encoder 303, as used herein, is configured to perform quantum data encoding, which transforms classical information into another form or representation, such as a quantum state representation derived from quantum circuit operations, including amplitudes or angles of quantum operations, such as rotation operations. While FIG. 3 illustrates multiple encoders 303, the contrastive learning approach of the present disclosure may utilize a single encoder 303, which may be applied to multiple different views 302.

In one embodiment, as shown in FIG. 3, such encoding performed by encoder 303 corresponds to angle encoding which represents views 302 in angles 304. In one embodiment, mapping engine 201 inputs such angles 304 into feature maps 305, which each correspond to a quantum circuit with optional neural network (NN) layers. Such feature maps 305 output the corresponding quantum state after angle encoding, such as after inputting the encoded values 304 into corresponding parameters in the quantum circuit and applying the quantum circuit to an initial state, such as the 0 state. By encoding data points with fewer qubits or as a part of a larger quantum state, the total quantum state may be more fully utilized thereby enabling the encoding of more data points or to perform other computations.

In one embodiment, encoder 303 implements angle encoding, which makes use of rotation gates (discussed further below) in feature maps 305 to encode classical information x. In one embodiment, the classical information determines the angles of the rotation gates:

$$\vert x 〉 = {{⊗}^{n}}_{i} R ( {x}_{i} ) \vert 0 \text{?} 〉 ,$$

$$\text{?} \text{indicates text missing or illegible when filed}$$

where R can be one of Rₓ, R_{y}, and R_{z}.

While FIG. 3 illustrates angle encoding, the principles of the present disclosure may utilize other types of encoding, such as amplitude encoding, instantaneous quantum polynomial (IQP) style encoding, and Hamiltonian evolution ansatz encoding.

In one embodiment, encoder 303 performs such encoding using a classical neural network. A neural network is a type of machine learning model derived from a type of machine learning process, often referred to as deep learning, that uses interconnected nodes or neurons in a layered structure that is modeled after a simplified abstraction of some parts of the human brain. It creates an adaptive system that computing devices can use to learn from their mistakes and improve continuously.

In one embodiment, encoders 303 utilize shared weights. Sharing weights, as used herein, refer to the reuse of weights on the nodes of the network (e.g., neural network) that are close to one another in a user-designated way. In this manner, weight sharing forces the neural network (NN) to detect common features of views 302 by applying the same weights across all views 302.

Furthermore, by encoders 303 utilizing shared weights, such encoders 303 can contrast views 302 from corruption, such as input corruption or quantum circuit noise, subsampling, etc.

In one embodiment, encoder 303 transforms the features of the different views 302 of data points 301 into a set of quantum circuit operations (performed by quantum circuits of feature map 305) to encode data point 301 into a quantum state, where the quantum state captures key information of data point 301.

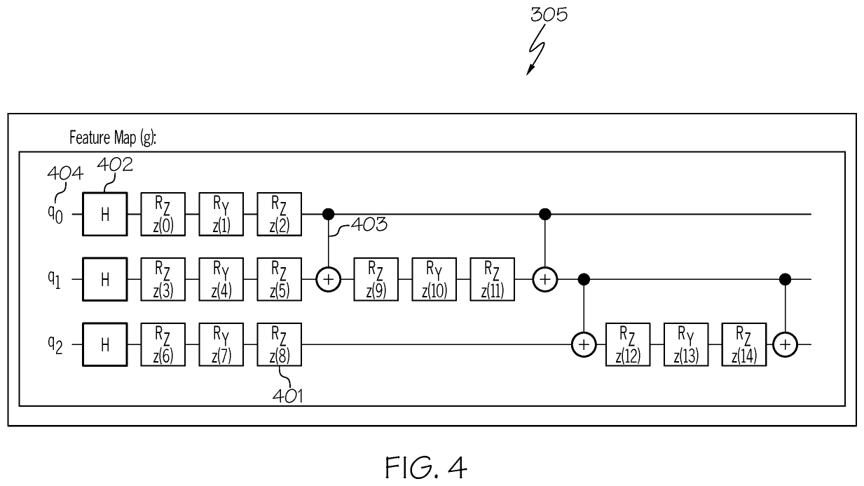

In one embodiment, encoder 303 detects common features of views 302, such as angles 304, which correspond to different sets of angles 304 from the inputted different views 302. As discussed above, such angles 304 are inputted to feature maps 305, corresponding to a quantum circuit with optional neural network layers. In one embodiment, such feature maps 305 correspond to parameterized quantum circuits which take the outputs of encoder 303 as the parameters for the quantum circuit for each input data point 301. An illustration of feature maps 305 is provided in FIG. 4.

FIG. 4 illustrates a feature map (feature map 305) in accordance with an embodiment of the present disclosure.

As shown in FIG. 4, feature map 305 corresponds to a diagram of a quantum circuit that includes rotation gates 401 (e.g., Rₓ, R_{y}, and R_{z}), Hadamard gates 402 (e.g., H), and entangling 2-qubit CNot gates 403 operating on the spaces of qubits 404 (qₒ, q₁, q₂).

Returning to FIG. 3, encoder 303 learns per the data set using contrastive learning. Similarly, any additional neural net layers, quantum or otherwise, of feature map 305, for example, parameterized rotation operations in addition to those corresponding to angle inputs 304, are also learned as part of this contrastive learning process. In one embodiment, loss functions are used for training the neural network of encoder 303 and any additional learnable parameters of feature map 305. In one embodiment, such a loss function is the InfoNCE loss function, where NCE stands for Noise-Contrastive Estimation. InfoNCE is a type of contrastive loss function used for self-supervised learning. In one embodiment, the InfoNCE loss function is used to train the neural network of encoder 303 in the presence of corruption, such as the random corruption of the features. Mathematical representations of the encoding given such random feature corruption is shown below:

$$sampled mini - batch {\{ {x}^{( i )} \}}_{i = 1}^{N}$$

$${z}^{( i )} = g ( f ( {x}^{( i )} ) ) , {\tilde{z}}^{( i )} ) ) = g ( f ( {\tilde{x}}^{( i )} ) ) , for i ∈ [ N ]$$

where x corresponds to the data (e.g., views 302), f corresponds to the encoder (e.g., encoder 303) and g corresponds to the feature map (e.g., feature map 305).

In one embodiment, encoder 303 is a multi-layer perceptron (MLP) encoder. A multi-layer perceptron is a feedforward artificial neural network, consisting of fully connected neurons with a nonlinear activation function, organized in at least three layers, namely, an input and an output layer with one or more hidden layers, of nonlinearly-activating nodes.

Furthermore, in one embodiment, feature maps 305 implement a shared structure so that such feature maps 305 output a correct quantum state (representation) after angle encoding.

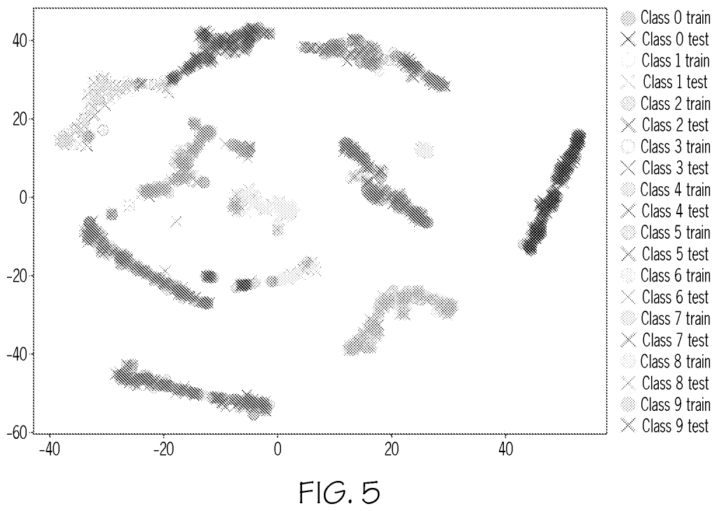

By utilizing the principles of the present disclosure, the classes of the learned quantum states (quantum state embeddings) are well grouped. For example, an illustration of embedding the quantum state features into two-dimensional space is provided in FIG. 5.

FIG. 5 illustrates embedding the quantum state features into two-dimensional space in accordance with an embodiment of the present disclosure.

In one embodiment, the data visualization method of t-stochastic neighbor embedding (t-SNE) is utilized, such as shown in FIG. 5. In one embodiment, t-SNE maps the data from the high-dimensional space into a low-dimensional space while maintaining the relationship or similarities between the surrounding points.

As shown in FIG. 5, utilizing t-SNE, the quantum state features are embedded into two-dimensional space. Despite not implementing supervised learning (labels are not used), classes of the learned quantum states (quantum state embeddings) are well grouped using the unsupervised contrastive learning of the present disclosure.

Returning to FIG. 2, in conjunction with FIGS. 1 and 3-5, in one embodiment, such representations (e.g., quantum state representations derived from quantum circuit operations) may be further transformed, such as a further classical transformation, in order to better learn to account for the noise of the quantum hardware. For example, a classical neural network may be utilized to transform measurements of observables from the quantum state. The final transformed version, such as the output of the last classical neural net, would then be the final representation.

In one embodiment, the contrastive learning approach of FIG. 3 further includes another trainable quantum or classical neural net after feature map 305 in order to further transform the representation (e.g., quantum state representation) thereby making the encoding more robust to account for quantum hardware noise. In another embodiment, such a trainable quantum or classical neural net may be considered as part of feature map 305.

In one embodiment, mapping engine 201 compares a similarity of the representations (e.g., quantum state representations derived from quantum circuit operations) of feature maps 305 among the different views 302 of data points 301 to form a similarity measure (see element 306 “state similarity measure”). In one embodiment, such state similarity is measured by mapping engine 201 using the SWAP test. Formally, the SWAP test takes two input states and outputs a Bernoulli random variable that is 1 with probability

$$\frac{1}{2} - \frac{1}{2} {\vert 〈 ψ \vert ϕ 〉 \vert}^{2} .$$

In another embodiment, such state similarity is measured by mapping engine 201 by using the compute-uncompute method, in which the series of rotations for one quantum state are followed by the inverted series of rotations for the second quantum state, and the probability of the 0 state at the output is then measured.

In another embodiment, such state similarity is measured by mapping engine 201 by measuring the distance between the quantum states using fuzzy similarity operators.

In one embodiment, mapping engine 201 optimizes the parameters of encoder 303 using the similarity measure. In one embodiment, such parameters of encoder 303 are optimized by updating the parameters of encoder 303 to maximize an objective via an iterative optimization process. Such an objective may correspond to ensuring that the different views 302 of data points 301 of the classical data have the property that a representation of a first data point of the classical data is more similar to a representation of a corrupted view of the first data point of the classical data on average than a similarity between the representation of the first data point of the classical data and a representation of a corrupted view of other data points of the classical data.

As a result of optimizing the parameters of encoder 303 in such a manner, an effective means for encoding the classical data is learned.

Furthermore, as a result of optimizing the parameters of encoder 303 in such a manner, encoder 303 is able to encode each data point 301 in a given dataset into a useful representation (e.g., quantum state representation) for the given quantum circuit of feature map 305 for such tasks as quantum machine learning using representations (e.g., quantum state representations derived from quantum circuit operations) of data points 301.

Furthermore, as a result of optimizing the parameters of encoder 303 in such a manner, such as over training data (classical data corresponding to training data), encoder 303 is effectively trained to encode the classical data to a representation (e.g., quantum state representation) for a given dataset or type of data. In this manner, once the encoder is trained, the encoder may be utilized to encode future data of the same type. Furthermore, the encoder may be trained utilizing a small number of features of the classical data and then be applied to encode classical data with a greater number of features using more qubits. In one embodiment, the encoder is able to encode classical data with a greater number of features using more qubits by using a particular encoder architecture that can be extended or applied to multiple or a variable number of features, such as a recurrent neural network or a transformer neural network architecture, and appropriately training these models, such as by varying the number of features during training, such as during each iteration of an optimization algorithm for a sampled batch of data. As a result, quantum machine learning is enabled to be used effectively with classical data with a large sample size and a large number of features.

Additionally, as a result of encoding classical data to representations, such representations (e.g., quantum state representations derived from quantum circuit operations) are effectively mapped into the quantum state space forming quantum data to be utilized to perform quantum machine learning on quantum computer 101 or quantum-enhanced machine learning that is a hybrid quantum and classical machine learning algorithm using both quantum and classical computing.

Classical computer 102 further includes a learning engine 202 configured to perform quantum machine learning on quantum computer 101 using the formed quantum data (quantum data formed from representations). As discussed above. the classical data mapped into the quantum state space forms quantum data. Quantum machine learning is then performed on quantum computer 101 using such formed quantum data. Additionally, such quantum data can be used to perform quantum-enhanced machine learning or hybrid quantum-classical machine learning, where a portion of the machine learning algorithm uses quantum computation with the quantum state and another portion of the machine learning algorithm uses classical computation with measurements of the quantum state.

Examples of such uses for quantum machine learning include developing new machine learning algorithms, speeding up already existing machine learning algorithms, employing quantum-enhanced reinforcement learning, creating quantum neural networks, etc.

A further description of these and other functions is provided below in connection with the discussion of the method for enabling quantum machine learning to be used effectively with classical data.

Prior to the discussion of the method for enabling quantum machine learning to be used effectively with classical data, a description of the hardware configuration of classical computer 102 (FIG. 1) is provided below in connection with FIG. 6.

Referring now to FIG. 6, in conjunction with FIG. 1, FIG. 6 illustrates an embodiment of the present disclosure of the hardware configuration of classical computer 102 which is representative of a hardware environment for practicing the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 600 contains an example of an environment for the execution of at least some of the computer code 601 involved in performing the inventive methods, such as enabling quantum machine learning to be used effectively with classical data. In addition to block 601, computing environment 600 includes, for example, classical computer 102, network 113, such as a wide area network (WAN), end user device (EUD) 602, remote server 603, public cloud 604, and private cloud 605. In this embodiment, classical computer 102 includes processor set 606 (including processing circuitry 607 and cache 608), communication fabric 609, volatile memory 610, persistent storage 611 (including operating system 612 and block 601, as identified above), peripheral device set 613 (including user interface (UI) device set 614, storage 615, and Internet of Things (IoT) sensor set 616), and network module 617. Remote server 603 includes remote database 618. Public cloud 604 includes gateway 619, cloud orchestration module 620, host physical machine set 621, virtual machine set 622, and container set 623.

Classical computer 102 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 618. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically classical computer 102, to keep the presentation as simple as possible. Classical computer 102 may be located in a cloud, even though it is not shown in a cloud in FIG. 6. On the other hand, classical computer 102 is not required to be in a cloud except to any extent as may be affirmatively indicated.

Processor set 606 includes one, or more, computer processors of any type now known or to be developed in the future. Processing circuitry 607 may be distributed over multiple packages, for example, multiple, coordinated integrated circuit chips. Processing circuitry 607 may implement multiple processor threads and/or multiple processor cores. Cache 608 is memory that is located in the processor chip package(s) and is typically used for data or code that should be available for rapid access by the threads or cores running on processor set 606. Cache memories are typically organized into multiple levels depending upon relative proximity to the processing circuitry. Alternatively, some, or all, of the cache for the processor set may be located “off chip.” In some computing environments, processor set 606 may be designed for working with qubits and performing quantum computing.

Computer readable program instructions are typically loaded onto classical computer 102 to cause a series of operational steps to be performed by processor set 606 of classical computer 102 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 608 and the other storage media discussed below. The program instructions, and associated data, are accessed by processor set 606 to control and direct performance of the inventive methods. In computing environment 600, at least some of the instructions for performing the inventive methods may be stored in block 601 in persistent storage 611.

Communication fabric 609 is the signal conduction paths that allow the various components of classical computer 102 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 610 is any type of volatile memory now known or to be developed in the future. Examples include dynamic type random access memory (RAM) or static type RAM. Typically, the volatile memory is characterized by random access, but this is not required unless affirmatively indicated. In classical computer 102, the volatile memory 610 is located in a single package and is internal to classical computer 102, but, alternatively or additionally, the volatile memory may be distributed over multiple packages and/or located externally with respect to classical computer 102.

Persistent Storage 611 is any form of non-volatile storage for computers that is now known or to be developed in the future. The non-volatility of this storage means that the stored data is maintained regardless of whether power is being supplied to classical computer 102 and/or directly to persistent storage 611. Persistent storage 611 may be a read only memory (ROM), but typically at least a portion of the persistent storage allows writing of data, deletion of data and re-writing of data. Some familiar forms of persistent storage include magnetic disks and solid state storage devices. Operating system 612 may take several forms, such as various known proprietary operating systems or open source Portable Operating System Interface type operating systems that employ a kernel. The code included in block 601 typically includes at least some of the computer code involved in performing the inventive methods.

Peripheral device set 613 includes the set of peripheral devices of classical computer 102. Data communication connections between the peripheral devices and the other components of classical computer 102 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 614 may include components such as a display screen, speaker, microphone, wearable devices (such as goggles and smart watches), keyboard, mouse, printer, touchpad, game controllers, and haptic devices. Storage 615 is external storage, such as an external hard drive, or insertable storage, such as an SD card. Storage 615 may be persistent and/or volatile. In some embodiments, storage 615 may take the form of a quantum computing storage device for storing data in the form of qubits. In embodiments where classical computer 102 is required to have a large amount of storage (for example, where classical computer 102 locally stores and manages a large database) then this storage may be provided by peripheral storage devices designed for storing very large amounts of data, such as a storage area network (SAN) that is shared by multiple, geographically distributed computers. IoT sensor set 616 is made up of sensors that can be used in Internet of Things applications. For example, one sensor may be a thermometer and another sensor may be a motion detector.

Network module 617 is the collection of computer software, hardware, and firmware that allows classical computer 102 to communicate with other computers through WAN 113. Network module 617 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 617 are performed on the same physical hardware device. In other embodiments (for example, embodiments that utilize software-defined networking (SDN)), the control functions and the forwarding functions of network module 617 are performed on physically separate devices, such that the control functions manage several different network hardware devices. Computer readable program instructions for performing the inventive methods can typically be downloaded to classical computer 102 from an external computer or external storage device through a network adapter card or network interface included in network module 617.

WAN 113 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 602 is any computer system that is used and controlled by an end user (for example, a customer of an enterprise that operates classical computer 102), and may take any of the forms discussed above in connection with classical computer 102. EUD 602 typically receives helpful and useful data from the operations of classical computer 102. For example, in a hypothetical case where classical computer 102 is designed to provide a recommendation to an end user, this recommendation would typically be communicated from network module 617 of classical computer 102 through WAN 113 to EUD 602. In this way, EUD 602 can display, or otherwise present, the recommendation to an end user. In some embodiments, EUD 602 may be a client device, such as thin client, heavy client, mainframe computer, desktop computer and so on.

Remote server 603 is any computer system that serves at least some data and/or functionality to classical computer 102. Remote server 603 may be controlled and used by the same entity that operates classical computer 102. Remote server 603 represents the machine(s) that collect and store helpful and useful data for use by other computers, such as classical computer 102. For example, in a hypothetical case where classical computer 102 is designed and programmed to provide a recommendation based on historical data, then this historical data may be provided to classical computer 102 from remote database 618 of remote server 603.

Public cloud 604 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 604 is performed by the computer hardware and/or software of cloud orchestration module 620. The computing resources provided by public cloud 604 are typically implemented by virtual computing environments that run on various computers making up the computers of host physical machine set 621, which is the universe of physical computers in and/or available to public cloud 604. The virtual computing environments (VCEs) typically take the form of virtual machines from virtual machine set 622 and/or containers from container set 623. It is understood that these VCEs may be stored as images and may be transferred among and between the various physical machine hosts, either as images or after instantiation of the VCE. Cloud orchestration module 620 manages the transfer and storage of images, deploys new instantiations of VCEs and manages active instantiations of VCE deployments. Gateway 619 is the collection of computer software, hardware, and firmware that allows public cloud 604 to communicate through WAN 113.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 605 is similar to public cloud 604, except that the computing resources are only available for use by a single enterprise. While private cloud 605 is depicted as being in communication with WAN 113 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 604 and private cloud 605 are both part of a larger hybrid cloud.

Block 601 further includes the software components discussed above in connection with FIGS. 2-5 to enable quantum machine learning to be used effectively with classical data. In one embodiment, such components may be implemented in hardware. The functions discussed above performed by such components are not generic computer functions. As a result, classical computer 102 is a particular machine that is the result of implementing specific, non-generic computer functions.

In one embodiment, the functionality of such software components of classical computer 102, including the functionality for enabling quantum machine learning to be used effectively with classical data, may be embodied in an application specific integrated circuit.

As stated above, quantum-enhanced machine learning refers to quantum or hybrid quantum-classical algorithms that solve tasks in machine learning, thereby improving and often expediting classical machine learning techniques. Such algorithms typically require one to encode the given classical data set into a quantum computer to make it accessible for quantum information processing, which is the process of converting the numeric representation on a classical computer, such as a vector of real numbers, into a quantum state of a quantum computer. Subsequently, quantum information processing routines are applied and the result of the quantum computation is read out by measuring characteristics of the quantum system. For example, the outcome of the measurement of a qubit (quantum mechanical analogue of a classical bit) can reveal the result of a binary classification task. Such classical data to be encoded by the quantum or hybrid quantum-classical algorithm may include a large sample size with a large number of features, which represent a measurable piece of data (e.g., name, sales) that can be used for analysis. Unfortunately, quantum machine learning can only be broadly applied to a small number of qubits and samples given current and near-term quantum computing technology. The current main approach to quantum machine learning on a quantum computer involves using on the order of 1 qubit per feature. However, since there are typically a large number of features in the classical data set, such an approach utilizes a sizeable number of qubits, often even more than the effective number of qubits of current and near-term quantum computers. Even when a quantum computer with a sufficient number of qubits exits, when such a large number of qubits are used, issues can arise, such as issues with shot requirements (a shot is an execution of the quantum circuit), curse of dimensionality (various phenomena that arise when analyzing and organizing data in high-dimensional spaces that do not occur in low-dimensional settings), measurement issues, such as a vanishingly small probability of measuring state overlaps even for similar states, noise, exponential concentration, etc. As a result, because there are such a large number of features in the classical data set, lossy compression (e.g., principal component analysis) is typically used to reduce the number of features in order to reduce the number of qubits, which typically results in poorer performance in comparison to classical machine learning using all of the features. Consequently, an approach has been developed that encodes multiple features per qubit as a sequence of rotations. Unfortunately, such an approach can lead to the loss of key information. Hence, there is not currently a means for broadly enabling quantum machine learning to be used effectively with classical data with a large sample size and a large number of features.

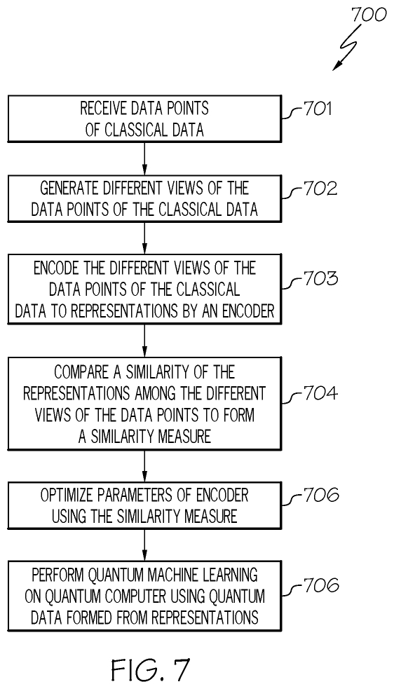

The embodiments of the present disclosure provide the means for enabling quantum machine learning to be used effectively with classical data with a large sample size and a large number of features while utilizing a small number of qubits as discussed below in connection with FIG. 7.

FIG. 7 is a flowchart of a method 700 for enabling quantum machine learning to be used effectively with classical data in accordance with an embodiment of the present disclosure.

Referring to FIG. 7, in conjunction with FIGS. 1-6, in step 701, mapping engine 201 of classical computer 102 receives data points 301 of classical data, which may consist of a large sample size and a large number of features, which represent a measurable piece of data (e.g., name, sales) that can be used for analysis.

In step 702, mapping engine 201 of classical computer 102 generates different views 302 of data points 301 of the classical data. “Views” 302, as used herein, refer to the different transformations being performed on the same data points 301.

As stated above, in one embodiment, mapping engine 201 generates different views 302 of data points 301 by corrupting data points 301 via different corruption mechanisms. “Corruption,” as used herein, refers to altering the data points, such as changing the values of the data points. In one embodiment, the different views 302 of data points 301 are generated via corruption of the classical data. In one embodiment, such corruption is performed by mapping engine 201 by purposely writing zeroes in the middle of the values of data points 301 at randomly chosen positions for each optimization iteration. In another embodiment, such corruption is performed by replacing randomly selected values with other values randomly sampled from the set of all values for the same feature.

Alternatively, in one embodiment, the different views 302 of data points 301 are generated via corruption of an initial encoded quantum state representation, such as by quantum hardware noise. In one embodiment, such corruption may occur at a latter stage in the process, such as when the data is encoded to the quantum state and as this quantum state is manipulated with quantum circuit operations. In one embodiment, the different views 302 of data points 301 are generated by applying quantum operations with different noise profiles, such as quantum operations with reduced or no noise and quantum operations exhibiting quantum hardware noise. For example, quantum operations with no noise may be applied, for example, via simulation, or with reduced noise via error-mitigation and suppression. In another example, noisy quantum hardware operations from quantum hardware noise are utilized for the alternative corrupted representation, such as in the case with no error mitigation or suppression. Examples of quantum hardware noise include, but are not limited to, local radiation, cosmic rays, influence neighboring qubits exert on each other, etc. In this manner, the learned encoding can adapt to the quantum hardware noise present in the system (i.e., the final encoding learns to be robust to this noise).

In step 703, mapping engine 201 of classical computer 102 encodes the different views 302 of data points 301 to representations, such as quantum state representations or new classical representations based on measurements of the quantum state and possible further classical transformations, using an encoder(s) 303. Such a process is referred to as “quantum data encoding” or “embedding.”

As stated above, an encoder 303, as used herein, is configured to perform quantum data encoding, which transforms classical information into another form or representation, such as a quantum state representation, including amplitudes or angles of quantum operations, such as rotation operations.

In one embodiment, as shown in FIG. 3, such encoding performed by encoder 303 corresponds to angle encoding which represents views 302 in angles 304. In one embodiment, mapping engine 201 inputs such angles 304 into feature maps 305, which each correspond to a quantum circuit with optional neural network (NN) layers. Such feature maps 305 output the corresponding quantum state after angle encoding, such as after inputting the encoded values 304 into corresponding parameters in the quantum circuit and applying the quantum circuit to an initial state, such as the 0 state. By encoding data points with fewer qubits or as a part of a larger quantum state, the total quantum state may be more fully utilized thereby enabling the encoding of more data points or to perform other computations.

In one embodiment, encoder 303 implements angle encoding, which makes use of rotation gates in feature maps 305 to encode classical information x. In one embodiment, the classical information determines the angles of the rotation gates:

$$\vert x 〉 = {{⊗}^{n}}_{i} R ( {x}_{i} ) \vert 0 \text{?} 〉 ,$$

$$\text{?} \text{indicates text missing or illegible when filed}$$

where R can be one of Rₓ, R_{y}, and R_{z}.

While FIG. 3 illustrates angle encoding, the principles of the present disclosure may utilize other types of encoding, such as amplitude encoding, instantaneous quantum polynomial (IQP) style encoding, and Hamiltonian evolution ansatz encoding.

In one embodiment, encoder 303 performs such encoding using a classical neural network. A neural network is a type of machine learning model derived from a type of machine learning process, often referred to as deep learning, that uses interconnected nodes or neurons in a layered structure that is modeled after a simplified abstraction of some parts of the human brain. It creates an adaptive system that computing devices can use to learn from their mistakes and improve continuously.

In one embodiment, encoders 303 utilize shared weights. Sharing weights, as used herein, refer to the reuse of weights on the nodes of the network (e.g., neural network) that are close to one another in a user-designated way. In this manner, weight sharing forces the neural network (NN) to detect common features of views 302 by applying the same weights across all views 302.

Furthermore, by encoders 303 utilizing shared weights, such encoders 303 can contrast views 302 from corruption, such as input corruption or quantum circuit noise, subsampling, etc.

In one embodiment, encoder 303 transforms the features of the different views 302 of data points 301 into a set of quantum circuit operations (performed by quantum circuits of feature map 305) to encode data point 301 into a quantum state, where the quantum state captures key information of data point 301.

In one embodiment, encoder 303 detects common features of views 302, such as angles 304, which correspond to different sets of angles 304 from the inputted different views 302. As discussed above, such angles 304 are inputted to feature maps 305, corresponding to a quantum circuit with optional neural network layers. In one embodiment, such feature maps 305 correspond to parameterized quantum circuits which take the outputs of encoder 303 as the parameters for the quantum circuit for each input data point 301. An illustration of feature maps 305 is provided in FIG. 4.

As shown in FIG. 4, feature map 305 corresponds to a diagram of a quantum circuit that includes rotation gates 401 (e.g., Rₓ, R_{y}, and R_{z}), Hadamard gates 402 (e.g., H), and entangling 2-qubit CNot gates 403 operating on the spaces of qubits 404 (qₒ, q₁, q₂).

In one embodiment, encoder 303 learns per the data set using contrastive learning. Similarly, any additional neural net layers, quantum or otherwise, of feature map 305, for example, parameterized rotation operations in addition to those corresponding to angle inputs 304, are also learned as part of this contrastive learning process. In one embodiment, loss functions are used for training the neural network of encoder 303 and any additional learnable parameters of feature map 305. In one embodiment, such a loss function is the InfoNCE loss function, where NCE stands for Noise-Contrastive Estimation. InfoNCE is a type of contrastive loss function used for self-supervised learning. In one embodiment, the InfoNCE loss function is used to train the neural network of encoder 303 in the presence of corruption, such as the random corruption of the features. Mathematical representations of the encoding given such random feature corruption is shown below:

$$sampled mini - batch {\{ {x}^{( i )} \}}_{i = 1}^{N}$$

$${z}^{( i )} = g ( f ( {x}^{( i )} ) ) , {\tilde{z}}^{( i )} ) ) = g ( f ( {\tilde{x}}^{( i )} ) ) , for i ∈ [ N ]$$

where x corresponds to the data (e.g., views 302), f corresponds to the encoder (e.g., encoder 303) and g corresponds to the feature map (e.g., feature map 305).

In one embodiment, encoder 303 is a multi-layer perceptron (MLP) encoder. A multi-layer perceptron is a feedforward artificial neural network, consisting of fully connected neurons with a nonlinear activation function, organized in at least three layers, namely, an input and an output layer with one or more hidden layers, of nonlinearly-activating nodes.

Furthermore, in one embodiment, feature maps 305 implement a shared structure so that such feature maps 305 output a correct quantum state (representation) after angle encoding.

By utilizing the principles of the present disclosure, the classes of the learned quantum states (quantum state embeddings) are well grouped. For example, an illustration of embedding the quantum state features into two-dimensional space is provided in FIG. 5.

In one embodiment, the data visualization method of t-stochastic neighbor embedding (t-SNE) is utilized, such as shown in FIG. 5. In one embodiment, t-SNE maps the data from the high-dimensional space into a low-dimensional space while maintaining the relationship or similarities between the surrounding points.

As shown in FIG. 5, utilizing t-SNE, the quantum state features are embedded into two-dimensional space. Despite not implementing supervised learning (labels are not used), classes of the learned quantum states (quantum state embeddings) are well grouped using the unsupervised contrastive learning of the present disclosure.

In one embodiment, such representations (e.g., quantum state representations derived from quantum circuit operations) may be further transformed, such as a further classical transformation, in order to better learn to account for the noise of the quantum hardware. For example, a classical neural network may be utilized to transform measurements of observables from the quantum state. The final transformed version, such as the output of the last classical neural net, would then be the final representation.

In one embodiment, the contrastive learning approach of FIG. 3 further includes another trainable quantum or classical neural net after feature map 305 in order to further transform the representation (e.g., quantum state representation) thereby making the encoding more robust to account for quantum hardware noise. In another embodiment, such a trainable quantum or classical neural net may be considered as part of feature map 305.

In step 704, mapping engine 201 of classical computer 12 compares a similarity of the representations (e.g., quantum state representations derived from quantum circuit operations) of feature maps 305 among the different views 302 of data points 301 to form a similarity measure (see element 306 “state similarity measure”).

As stated above, in one embodiment, such state similarity is measured by mapping engine 201 using the SWAP test. Formally, the SWAP test takes two input states and outputs a Bernoulli random variable that is 1 with probability

$$\frac{1}{2} - \frac{1}{2} {\vert 〈 ψ \vert ϕ 〉 \vert}^{2} .$$

In another embodiment, such state similarity is measured by mapping engine 201 by using the compute-uncompute method, in which the series of rotations for one quantum state are followed by the inverted series of rotations for the second quantum state, and the probability of the 0 state at the output is then measured.

In another embodiment, such state similarity is measured by mapping engine 201 by measuring the distance between the quantum states using fuzzy similarity operators.

In step 705, mapping engine 201 of classical computer 102 optimizes the parameters of encoder 303 using the similarity measure.

As discussed above, in one embodiment, such parameters of encoder 303 are optimized by updating the parameters of encoder 303 to maximize an objective via an iterative optimization process. Such an objective may correspond to ensuring that the different views 302 of data points 301 of the classical data have the property that a representation of a first data point of the classical data is more similar to a representation of a corrupted view of the first data point of the classical data on average than a similarity between the representation of the first data point of the classical data and a representation of a corrupted view of other data points of the classical data.

As a result of optimizing the parameters of encoder 303 in such a manner, an effective means for encoding the classical data is learned.

Furthermore, as a result of optimizing the parameters of encoder 303 in such a manner, encoder 303 is able to encode each data point 301 in a given dataset into a useful representation (e.g., quantum state representation) for the given quantum circuit of feature map 305 for such tasks as quantum machine learning using representations (e.g., quantum state representations derived from quantum circuit operations) of data points 301.

Furthermore, as a result of optimizing the parameters of encoder 303 in such a manner, such as over training data (classical data corresponding to training data), encoder 303 is effectively trained to encode the classical data to a representation (e.g., quantum state representation) for a given dataset or type of data. In this manner, once the encoder is trained, the encoder may be utilized to encode future data of the same type. Furthermore, the encoder may be trained utilizing a small number of features of the classical data and then be applied to encode classical data with a greater number of features using more qubits. In one embodiment, the encoder is able to encode classical data with a greater number of features using more qubits by using a particular encoder architecture that can be extended or applied to multiple or a variable number of features, such as a recurrent neural network or a transformer neural network architecture, and appropriately training these models, such as by varying the number of features during training, such as during each iteration of an optimization algorithm for a sampled batch of data. As a result, quantum machine learning is enabled to be used effectively with classical data with a large sample size and a large number of features.

Additionally, as a result of encoding classical data to representations, such representations (e.g., quantum state representations derived from quantum circuit operations) are effectively mapped into the quantum state space forming quantum data to be utilized to perform quantum machine learning on quantum computer 101 or quantum-enhanced machine learning that is a hybrid quantum and classical machine learning algorithm using both quantum and classical computing.

In step 706, learning engine 202 of classical computer 102 performs quantum machine learning on quantum computer 101 using the formed quantum data (quantum data formed from representations). As discussed above. the classical data mapped into the quantum state space forms quantum data. Quantum machine learning is then performed on quantum computer 101 using such formed quantum data. Additionally, such quantum data can be used to perform quantum-enhanced machine learning or hybrid quantum-classical machine learning, where a portion of the machine learning algorithm uses quantum computation with the quantum state and another portion of the machine learning algorithm uses classical computation with measurements of the quantum state.

Examples of such uses for quantum machine learning include developing new machine learning algorithms, speeding up already existing machine learning algorithms, employing quantum-enhanced reinforcement learning, creating quantum neural networks, etc.

As a result of the foregoing, quantum machine learning is enabled to be used effectively with classical data with a large sample size and a large number of features while utilizing a small number of qubits.

Furthermore, the principles of the present disclosure improve the technology or technical field involving quantum machine learning.

As discussed above, quantum-enhanced machine learning refers to quantum or hybrid quantum-classical algorithms that solve tasks in machine learning, thereby improving and often expediting classical machine learning techniques. Such algorithms typically require one to encode the given classical data set into a quantum computer to make it accessible for quantum information processing, which is the process of converting the numeric representation on a classical computer, such as a vector of real numbers, into a quantum state of a quantum computer. Subsequently, quantum information processing routines are applied and the result of the quantum computation is read out by measuring characteristics of the quantum system. For example, the outcome of the measurement of a qubit (quantum mechanical analogue of a classical bit) can reveal the result of a binary classification task. Such classical data to be encoded by the quantum or hybrid quantum-classical algorithm may include a large sample size with a large number of features, which represent a measurable piece of data (e.g., name, sales) that can be used for analysis. Unfortunately, quantum machine learning can only be broadly applied to a small number of qubits and samples given current and near-term quantum computing technology. The current main approach to quantum machine learning on a quantum computer involves using on the order of 1 qubit per feature. However, since there are typically a large number of features in the classical data set, such an approach utilizes a sizeable number of qubits, often even more than the effective number of qubits of current and near-term quantum computers. Even when a quantum computer with a sufficient number of qubits exits, when such a large number of qubits are used, issues can arise, such as issues with shot requirements (a shot is an execution of the quantum circuit), curse of dimensionality (various phenomena that arise when analyzing and organizing data in high-dimensional spaces that do not occur in low-dimensional settings), measurement issues, such as a vanishingly small probability of measuring state overlaps even for similar states, noise, exponential concentration, etc. As a result, because there are such a large number of features in the classical data set, lossy compression (e.g., principal component analysis) is typically used to reduce the number of features in order to reduce the number of qubits, which typically results in poorer performance in comparison to classical machine learning using all of the features. Consequently, an approach has been developed that encodes multiple features per qubit as a sequence of rotations. Unfortunately, such an approach can lead to the loss of key information. Hence, there is not currently a means for broadly enabling quantum machine learning to be used effectively with classical data with a large sample size and a large number of features.

Embodiments of the present disclosure improve such technology by generating different views of the data points of the classical data, which may consist of a large sample size and a large number of features. Such different views of the data points may be generated via corruption of the classical data or corruption of an initial encoded quantum state representation by quantum hardware noise. Such different views of the data points of the classical data may then be encoded to representations (e.g., quantum state representations) by an encoder. A similarity of the representations among the different views of the data points of the classical data may then be compared to form a similarity measure, which is used to optimize the parameters of the encoder. By optimizing the parameters of the encoder in such a manner, the final representations for the different views of the data points of the classical data have the property that a representation of a first data point of the classical data is more similar to a representation of a corrupted view of the first data point of the classical data on average than a similarity between the representation of the first data point of the classical data and a representation of a corrupted view of other data points of the classical data. As a result of optimizing the parameters of the encoder, such as over training data (classical data corresponding to training data), the encoder is effectively trained to encode the classical data to a representation (e.g., quantum state representation) for a given dataset or type of data. In this manner, once the encoder is trained, the encoder may be utilized to encode future data of the same type. Furthermore, the encoder may be trained utilizing a small number of features of the classical data and then be applied to encode classical data with a greater number of features using more qubits. As a result, quantum machine learning is enabled to be used effectively with classical data with a large sample size and a large number of features. Furthermore, in this manner, there is an improvement in the technical field involving quantum machine learning.

The technical solution provided by the present disclosure cannot be performed in the human mind or by a human using a pen and paper. That is, the technical solution provided by the present disclosure could not be accomplished in the human mind or by a human using a pen and paper in any reasonable amount of time and with any reasonable expectation of accuracy without the use of a computer.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for enabling quantum machine learning to be used effectively with classical data, the method comprising:
receiving said classical data;
mapping said classical data into a quantum state space forming quantum data using a classical machine learning model; and
performing said quantum machine learning on a quantum computer using said formed quantum data.

2. The method as recited in claim 1 further comprising:
receiving data points of said classical data;
generating different views of said data points of said classical data;
encoding said different views of said data points of said classical data by an encoder to representations;
comparing a similarity of said representations among said different views of said data points of said classical data to form a similarity measure; and
optimizing parameters of said encoder using said similarity measure.

3. The method as recited in claim 2, wherein said representations correspond to quantum state representations derived from quantum circuit operations.

4. The method as recited in claim 2, wherein said different views of said data points of said classical data are generated via corruption of said classical data or corruption of an initial encoded quantum state representation by quantum hardware noise.

5. The method as recited in claim 2, wherein said parameters of said encoder are optimized using said similarity measure such that a final quantum state representation of said different views 2 of said data points of said classical data has a property that a representation of a first data point of said classical data is more similar to a representation of a corrupted view of said first data point of said classical data on average than a similarity between said representation of said first data point of said classical data and a representation of a corrupted view of other data points of said classical data.

6. The method as recited in claim 2, wherein said data points of said classical data correspond to a first type of data, wherein said encoder is trained to encode different views of other data points of said first type of data of said classical data across different data sets.

7. The method as recited in claim 2, wherein said representations correspond to quantum state representations or new classical representations.

8. A computer program product for enabling quantum machine learning to be used effectively with classical data, the computer program product comprising one or more computer readable storage mediums having program code embodied therewith, the program code comprising programming instructions for:
receiving said classical data;
mapping said classical data into a quantum state space forming quantum data using a classical machine learning model; and
performing said quantum machine learning on a quantum computer using said formed quantum data.

9. The computer program product as recited in claim 8, wherein the program code further comprises the programming instructions for:
receiving data points of said classical data;
generating different views of said data points of said classical data;
encoding said different views of said data points of said classical data by an encoder to representations;
comparing a similarity of said representations among said different views of said data points of said classical data to form a similarity measure; and
optimizing parameters of said encoder using said similarity measure.

10. The computer program product as recited in claim 9, wherein said representations correspond to quantum state representations derived from quantum circuit operations.

11. The computer program product as recited in claim 9, wherein said different views of said data points of said classical data are generated via corruption of said classical data or corruption of an initial encoded quantum state representation by quantum hardware noise.

12. The computer program product as recited in claim 9, wherein said parameters of said encoder are optimized using said similarity measure such that a final quantum state representation of said different views of said data points of said classical data has a property that a representation of a first data point of said classical data is more similar to a representation of a corrupted view of said first data point of said classical data on average than a similarity between said representation of said first data point of said classical data and a representation of a corrupted view of other data points of said classical data.

13. The computer program product as recited in claim 9, wherein said data points of said classical data correspond to a first type of data, wherein said encoder is trained to encode different views of other data points of said first type of data of said classical data across different data sets.

14. The computer program product as recited in claim 9, wherein said representations correspond to quantum state representations or new classical representations.

15. A system, comprising:
a memory for storing a computer program for enabling quantum machine learning to be used effectively with classical data; and
a processor connected to said memory, wherein said processor is configured to execute program instructions of the computer program comprising:
receiving said classical data;
mapping said classical data into a quantum state space forming quantum data using a classical machine learning model; and
performing said quantum machine learning on a quantum computer using said formed quantum data.

16. The system as recited in claim 15, wherein the program instructions of the computer program further comprise:
receiving data points of said classical data;
generating different views of said data points of said classical data;
encoding said different views of said data points of said classical data by an encoder to representations;
comparing a similarity of said representations among said different views of said data points of said classical data to form a similarity measure; and
optimizing parameters of said encoder using said similarity measure.

17. The system as recited in claim 16, wherein said representations correspond to quantum state representations derived from quantum circuit operations.

18. The system as recited in claim 16, wherein said different views of said data points of said classical data are generated via corruption of said classical data or corruption of an initial encoded quantum state representation by quantum hardware noise.

19. The system as recited in claim 16, wherein said parameters of said encoder are optimized using said similarity measure such that a final quantum state representation of said different views of said data points of said classical data has a property that a representation of a first data point of said classical data is more similar to a representation of a corrupted view of said first data point of said classical data on average than a similarity between said representation of said first data point of said classical data and a representation of a corrupted view of other data points of said classical data.

20. The system as recited in claim 16, wherein said data points of said classical data correspond to a first type of data, wherein said encoder is trained to encode different views of other data points of said first type of data of said classical data across different data sets.
